(19) United States
(12) Patent Application Publication
(10) Pub. No.: US 2025/0264329 A1
(43) Pub. Date: Aug. 21, 2025

(54) Systems and Methods for Performing Leveled Automotive Service Over Unlevel Surfaces

(71) Applicant: MONLIZ LLC, Sacramento, CA (US)

(72) Inventors: Robert Monaghan, Ventura, CA (US); Lee Lizarraga, Ventura, CA (US); Steven A. Tobenkin, Las Vegas, NV (US)

(73) Assignee: MONLIZ LLC, Sacramento, CA (US)

(21) Appl. No.: 18/581,133

(22) Filed: Feb. 19, 2024

(51) Int. Cl. G01B 11/275

(52) U.S. Cl. CPC G01B 11/275

(57) ABSTRACT

A vehicle service system and associated methods perform leveled automotive service over unlevel surfaces. The system maps the ground surface on which a vehicle is to be serviced, verifies whether the ground surface or the vehicle over the ground surface is level based on the mapping, and adjusts service output to compensate for affects that an unlevel surface or vehicle position have on the service. The system receives a map with values for different heights measured across a surface, determines a level of the vehicle located at a first position on the surface based on the values for the different heights specified at the first position in the map, and adjusts outputs associated with servicing the vehicle based on the determined level of the vehicle.

### BACKGROUND

Some automotive repair, maintenance, tuning, and/or other service requires the vehicle to be level or on a level surface when the adjustments associated with the service are made. Otherwise, the adjustments may be made incorrectly which may affect vehicle driving characteristics or performance.

For instance, wheel alignment that is performed with the vehicle on an unlevel surface may result in the wheels being adjusted incorrectly relative to the centerline of the vehicle. Consequently, the incorrectly aligned wheels may cause the vehicle to improperly drift or pull, drive abnormally, or cause excessive wear on the vehicle tires.

Driver assist functionality (e.g., automatic lane keeping, adaptive cruise control, obstacle avoidance, collision prevention, etc.) may also be affected and operate incorrectly or unexpectedly when the sensors for the driver assist functionality are incorrectly calibrated as a result of the vehicle or the calibration targets used for the sensor calibration not being level relative to one another during calibration. The incorrectly calibrated driver assist functionality and/or sensors may cause the vehicle to veer out of its lane while in a self-driving mode or when automatic lane keeping is activated, maintain an unsafe distance during adaptive cruise control, not detect obstacles that are in the vehicle path, and/or improperly detect obstacles to be in the vehicle path when they are not.

Vehicle lifts may raise the vehicle to be perfectly level. However, some service work cannot be performed or are difficult to perform while the vehicle is lifted off the ground. Vehicle lifts are also expensive to install and support only one vehicle at a time.

### BRIEF DESCRIPTION OF THE DRAWINGS

FIG. 1 illustrates an example of mapping the ground surface as part of performing leveled automotive service over unlevel surfaces in accordance with some embodiments presented herein.

FIG. 2 illustrates an example of mapping the ground surface based on a set of vehicle sensors in accordance with some embodiments presented herein.

FIG. 3 presents a process for performing leveled automotive service over an unlevel surface in accordance with some embodiments presented herein.

FIG. 4 illustrates an example of performing a dynamically adjusted wheel alignment to compensate for an unlevel surface in accordance with some embodiments presented herein.

FIG. 5 illustrates an example of performing a dynamically adjusted calibration to correct for affects an unlevel surface has on the calibration in accordance with some embodiments presented herein.

FIG. 6 illustrates an example of automatically controlling vehicle service in response to verifying dynamically adjusted settings and/or parameters for the vehicle service in accordance with some embodiments presented herein.

FIG. 7 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and methods for performing leveled automotive service over unlevel surfaces. The systems and methods including mapping the ground surface on which a vehicle is to be serviced, and verifying whether the ground surface is level based on the mapping. For an unlevel surface, the systems and methods may incorporate or use the generated map of the ground surface to compensate for irregularities or unevenness in the ground surface when diagnosing the vehicle, obtaining vehicle measurements, and/or performing service on the vehicle. For instance, the systems and methods may dynamically adjust measurements produced by one or more sensors based on the positions of the one or more sensors and any detected unevenness or irregularities at those positions.

By dynamically adjusting the output that is used to service the vehicle and compensate for variations in the level of the ground surface, the systems and methods enable vehicles to be serviced while positioned over an unlevel surface without the surface or surface irregularities negatively affecting the service or performance of the vehicle after it is serviced over the unlevel surface. In other words, the systems and methods account and compensate for the unevenness or irregularities of the ground surface on which a vehicle is being serviced so that the service technicians are provided with dynamically modified measurements and instructions for making the same adjustments that would be made if the vehicle was positioned over a level surface.

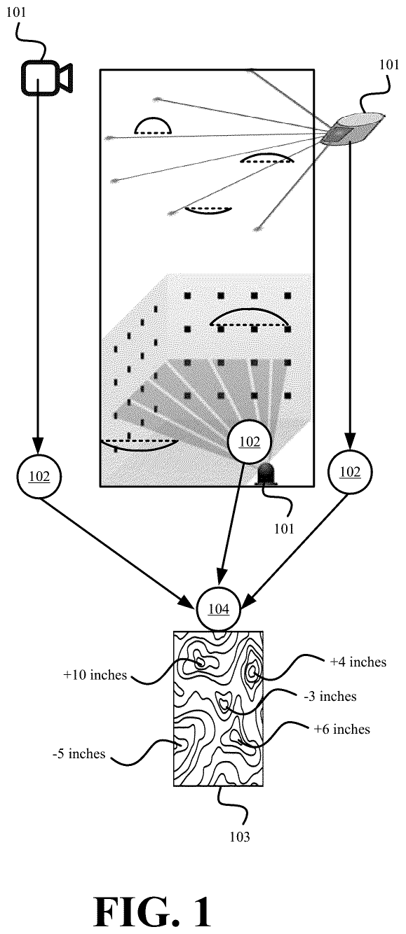

FIG. 1 illustrates an example of mapping the ground surface as part of performing leveled automotive service over unlevel surfaces in accordance with some embodiments presented herein. One or more mapping devices 101 may scan, measure, or image (at 102) the ground surface using structured light, time-of-flight, Light Detection and Ranging (LiDAR), photogrammetry, or other mapping or depth-measurement techniques. Mapping devices 101 may generate (at 104) topographical map 103 of the ground surface based on the scan results, measurements, or images. Topographical map 103 is defined with values to represent height variations across the ground surface caused by bumps, divots, changing slope, changing curvature, surface abnormalities or irregularities, and/or other differences across the surface.

For instance, mapping devices 101 may project a structured light pattern across the ground surface, may image the structured light pattern, and may generate (at 104) topographical map 103 of the ground surface based on measured deviations in the structured light pattern at different positions across the ground surface. Specifically, mapping devices 101 may determine a 3D position for each point of the ground surface that is illuminated with the structured light pattern based on a difference between an expected deviation of the structured light pattern at that position and an actual imaged deviation.

Mapping devices 101, also or alternatively, may emit laser, light, sound, or other signals and measure the time it takes those signals to reflect off different points of the ground surface and return to mapping devices 101. Based on the measured time-of-flight, angle-of-incidence, and/or other characteristics of the returning signal, mapping devices may determine a 3D position for each point of the ground surface that a signal reflects off, and may generate (at 104) topographical map 103 based on the determined 3D positions.

In some embodiments, mapping devices 101 use LiDAR to map the positions of different points across the ground surface. In some other embodiments, mapping devices 101 include one or more cameras that capture images of the ground surface from different positions. Photogrammetry techniques may be used to process the images, determine 3D positions for each point of the ground surface based on variations in the imaging of that point in the different images, and generate (at 104) topographical map 103 based on the determined 3D positions.

In some embodiments, outputs from one or more mapping devices 101 may be used to generate (at 104) topographical map 103 of the ground surface. Topographical map 103 may have an accuracy that is within desired thresholds. For instance, the measurements associated with topographical map 103 may have up to one centimeter or millimeter accuracy depending on the scanning or imaging technique used to generate (at 104) topographical map 103.

In some embodiments, a vehicle service system may receive topographical map 103 from mapping devices 101 or may generate (at 104) topographical map 103 based on the scan, measurement, and/or image outputs from mapping devices 101. The vehicle service system may analyze topographical map 103 for variation across the ground surface. Specifically, the vehicle service system determines if the level of the ground surface changes by more than a threshold amount at any point. The level of the ground surface changes when the z-coordinate value or height value at any position differs by more than the threshold amount from the z-coordinate value or height value at other positions in topographical map 103. In some embodiments, the vehicle service system detects the unlevel positions within topographical map 103 and identifies the unlevel positions with visual markers or identifiers. A service technician may reference the visual markers in order to avoid placing a vehicle, calibration equipment, and/or other service tools, devices, or systems at the unlevel positions.

The vehicle service system may use and/or provide the topographical map of a service site that is confirmed to be level to satisfy requirements and/or standards set for vehicle service. For instance, the vehicle service system may provide an electronic message or the topographical map that verifies the service site is level to an insurer, vehicle manufacturer, or other party. The electronic message or the topographical map may be used as verification that that service performed at the service site meets requirements or standards set forth by insurer, vehicle manufacturer, or other party. The verification may be required prior to the insurer reimbursing the service site for completed work and/or the vehicle manufacture or other party providing a warranty or guarantee for the service performed at the service site. In some embodiments, the insurer or vehicle manufacturer may require certification that the ground surface at the site is level before authorizing work to be completed at that site or certifying the site as an authorized service location.

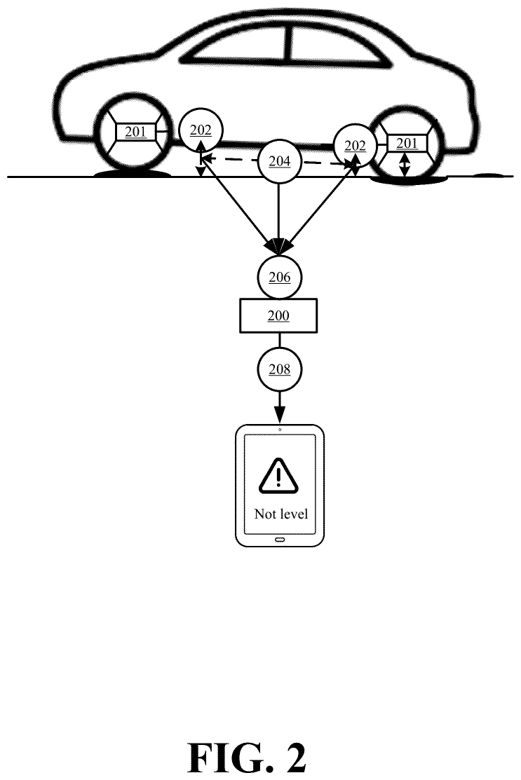

In some embodiments, the vehicle service system may generate the topographical map or may determine the level of the ground surface based on sensors mounted or attached to the vehicle. FIG. 2 illustrates an example of mapping the ground surface based on a set of vehicle sensors in accordance with some embodiments presented herein.

Sensor packages 201 may be mounted or attached to the vehicle wheels or other vehicle components so that they are distributed about the four corners of the vehicle. Sensor packages 201 may be used to track the rotation of the wheels for alignment or other purposes. Sensor packages 201 may include one or more of an accelerometer, inertial measurement unit (IMU), gyroscope, Ultra-Wide Band (UWB) radio, altimeter, and/or other rotational or positional sensors. In some embodiments, the altimeter or positional sensor may obtain (at 202) a height measurement for the distance between that sensor and the ground surface. Moreover, sensor packages 201 may use UWB signaling to determine (at 204) vertical offsets between each pair of sensor packages 201. Sensor packages 201 may provide (at 206) the height measurements and/or measured vertical offsets to vehicle sensor system 200, and vehicle sensor system 200 may compare the height measurements to determine and report (at 208) whether the vehicle is level or over a level surface.

In some embodiments, sensor package 201 measurements may be combined or used in conjunction with the topographical map for additional verification that the automotive service is performed over a level surface and/or with the vehicle being perfectly level. For instance, unevenly worn or inflated tires as well as unevenly worn or damaged shocks, struts, linkage bars, axels, and/or other vehicle components may cause the vehicle to be unlevel even when the vehicle is positioned over a perfectly level ground surface. In some such embodiments, sensor package 201 measurements combined with the topographical map may identify the cause of the unlevel vehicle position and allow the service technician to make the correct repairs or adjustments.

In some embodiments, the measurements from sensor packages 201 may be combined with measurements from external sensors that are not mounted to vehicle to verify correct 3D positioning of calibration targets and/or other hardware used for automotive service. For instance, a vehicle advanced driver-assistance system (ADAS) requires precise calibration for correct operation. The ADAS relies on radar, cameras, and/or other vehicle sensors to control various safety features and automatic driving functionality. The ADAS sensors are calibrated using targets that must be positioned at precise locations that are specified by the vehicle manufacture or ADAS provider and that determined relative to the vehicle position. If the distance or height of the targets is off by even a small amount (e.g., a few inches), the ADAS may be incorrectly calibrated which may cause unexpected, incorrect, and potentially dangerous vehicle behavior. Accordingly, a sensor package may be placed on a calibration target and may communicate positional information with the sensor packages mounted to the vehicle wheels. Vehicle service system 200 may receive the measurements from each sensor package, may compare the measurements, and may verify whether the calibration target is placed at the correct distance, offset position, and height relative to the vehicle based on the measurements.

In some embodiments, vehicle service system 200 dynamically and automatically adjusts measurements taken from various sensors, specifications for calibrating or servicing the vehicle, and/or operations for servicing the vehicle to correct for the impact that an unlevel vehicle has on the measurements, specifications, and/or operations. In some such embodiments, vehicle service system 200 may receive the topographical map and may dynamically account for any surface irregularities of an unlevel surface when diagnosing, measuring, or providing service for the vehicle positioned over that unlevel surface. Vehicle service system 200 may adjust the measurements, specifications, and/or operations so that the automotive service may be completed over an unlevel surface or with an unlevel vehicle in the same manner as if the vehicle was perfectly level and without the surface irregularities affecting the service or vehicle condition after the service is performed over the unlevel surface.

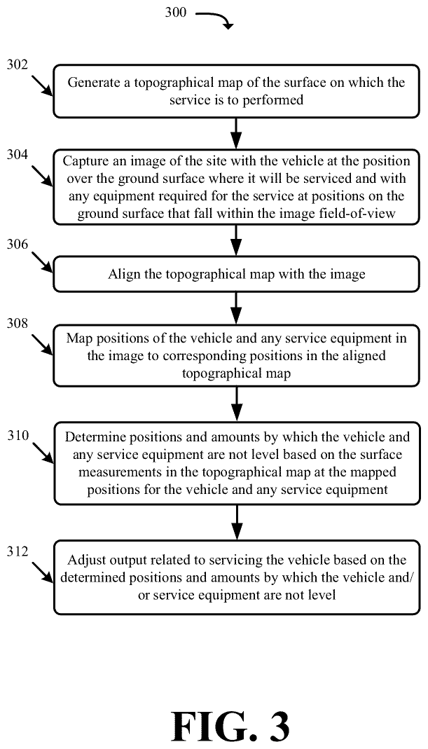

FIG. 3 presents a process 300 for performing leveled automotive service over an unlevel surface in accordance with some embodiments presented herein. Process 300 is implemented by vehicle service system 200.

Vehicle service system 200 includes one or more devices, machines, tools, and/or other equipment with processor, memory, storage, network, and/or other hardware resources for servicing vehicles over unlevel surfaces. Specifically, vehicle service system 200 is used to perform vehicle service that requires a level surface or the vehicle to be level without the vehicle being level or on a level surface. For instance, the vehicle service system may be used to perform accurate wheel alignment, ADAS calibration, and/or other repair, maintenance, tuning, or calibration over unlevel surfaces or with the vehicle not being level during the service without the uneven positioning of the vehicle biasing the measurements or adjustments made to the vehicle.

Process 300 includes generating (at 302) a topographical map of the surface on which the service is to performed. Vehicle service system 200 may include or integrate with mapping devices 101 for the scanning or imaging of the surface and for obtaining the data (e.g., time-of-flight measurements, LiDAR positional measurements, images for photogrammetry or 3D modeling, etc.) from which to generate (at 302) the topographical map. For instance, mapping devices 101 may include a handheld device (e.g., smartphone, tablet, laptop computer, spatial computing headset or wearable device, etc.) with LiDAR, time-of-flight, imaging, structured light, and/or other depth-sensing or positional measuring functionality. In some embodiments, mapping devices 101 directly generate (at 302) the topographical map of a site, and provide the generated topographical map to vehicle service system 200. In some embodiments, the topographical map for a site is generated (at 302) once and is stored and reused by the vehicle service system for any subsequent service performed at the mapped site. In some embodiments, the topographical map overlays the measured heights or representation of the measured heights for different points across the surface atop a visual image of the surface.

Process 300 includes capturing (at 304) an image of the site with the vehicle at the position over the ground surface where it will be serviced and with any equipment required for the service at positions on the ground surface that fall within the image field-of-view. The image may be captured (at 304) with a digital camera and/or with mapping devices 101. The image may be captured (at 304) from the same or a different position used to generate (at 302) the topographical map. In some embodiments, multiple images of the site may be captured (at 304) to image all sides of the vehicle.

Process 300 includes aligning (at 306) the topographical map with the image. Vehicle service system 200 aligns (at 306) the topographical map with the image based on common points-of-reference that are captured (at 304) in the image and that are retained in or associated with the topographical map. For instance, the same common points-of-reference may be associated to positions in the topographical map that correspond to the positions for the points-of-reference in the site. In some embodiments, the topographical map represents the heights of the ground surface, includes coordinates that map to corresponding positions in the site at which the heights were measured, and further includes visual marker or identifiers to indicate the positions of the common points-of-reference.

The common points-of-reference may include any differentiable visual fiducial on the surface, over the surface, or that is visible in the site and that is detected during the topographical map generation (at 302) and site imaging. For instance, prior to generating (at 302) the topographical map and capturing (at 304) the image of the vehicle over the surface, a user may place one or more visual fiducials (e.g., unique shapes, forms, or colors) at different positions about the surface to serve as the points-of-reference. The points-of-reference may also correspond to existing features on the surface or in the site containing the surface. For instance, a desk with a specific form may serve as a first point-of-reference and a specific sign hanging on a wall may serve as a second point-of-reference.

Aligning (at 306) the topographical map with the image may include transforming the image (e.g., rotating, resizing, skewing, and/or otherwise modifying the image) so that the points-of-reference in the transformed image at the same positions as in the topographical map. Aligning (at 306) the topographical map with the image may also include transforming the topographical map so that the site positions represented by the topographical map are at the same positions as they are in the captured (at 304) image of the site.

Process 300 includes mapping (at 308) positions of the vehicle and any service equipment in the image to corresponding positions in the aligned (at 306) topographical map, and determining (at 310) positions and amounts by which the vehicle and any service equipment are not level based on the surface measurements in the topographical map at the mapped (at 308) positions for the vehicle and any service equipment. For instance, vehicle service system 200 determines (at 310) whether the vehicle and the service equipment are level and/or at the same height or whether the vehicle or the service equipment are positioned over unlevel points of the ground surface.

Process 300 includes adjusting (at 312) output related to servicing the vehicle based on the determined (at 310) positions and amounts by which the vehicle and/or service equipment are not level. The adjusted output is generated by vehicle service system 200. The adjusted output may correct for a variety of service related tasks that would otherwise be affected by unlevel placement of the vehicle or service equipment.

In some embodiments, vehicle service system 200 adjusts (at 312) measurements that are produced for diagnosing vehicle issues (e.g., wheel misalignment) based on the determined (at 310) positions and amounts by which the vehicle and/or service equipment are not level. Specifically, camber measurements for the vehicle wheels may be affected if the wheels are not level relative to one another. Vehicle service system 200 determines the amount by which the wheels are not level relative to one another, the affect that the different wheel positions have on the camber measurements, and adjusts (at 312) the camber measurements to compensate and correct for the affect that the unlevel wheels have on the camber measurements. In some such embodiments, vehicle service system 200 adjusts (at 312) the measurements in real-time as they are generated by sensors on the vehicle or by sensors of the service equipment that are located off the vehicle. In some other embodiments, vehicle service system 200 adjusts (at 312) the measurements after they are generated by the sensors and before they are presented on a user interface or other display.

In some embodiments, vehicle service system 200 adjusts (at 312) the specified positioning of the service equipment to account for one or more of the vehicle or the service equipment being positioned at a surface location that is not level in the topographical map. For instance, vehicle service system 200 may specify lowering the position of an ADAS calibration target from a specified height in response to determining that the ADAS calibration target location is elevated in the topographical map relative to the position of the vehicle.

In some embodiments, vehicle service system 200 adjusts (at 312) tuning parameters or adjustments to be made to one or more vehicle components to account for one or more of the vehicle or the service equipment being positioned at a surface location that is not level in the topographical map. For instance, the vehicle may be positioned on a slope (e.g., a driveway) which may affect the throttle response of the vehicle. Vehicle service system 200 may adjust (at 312) the amount with which to tune the throttle response to account for the affect that the slope has on the throttle response.

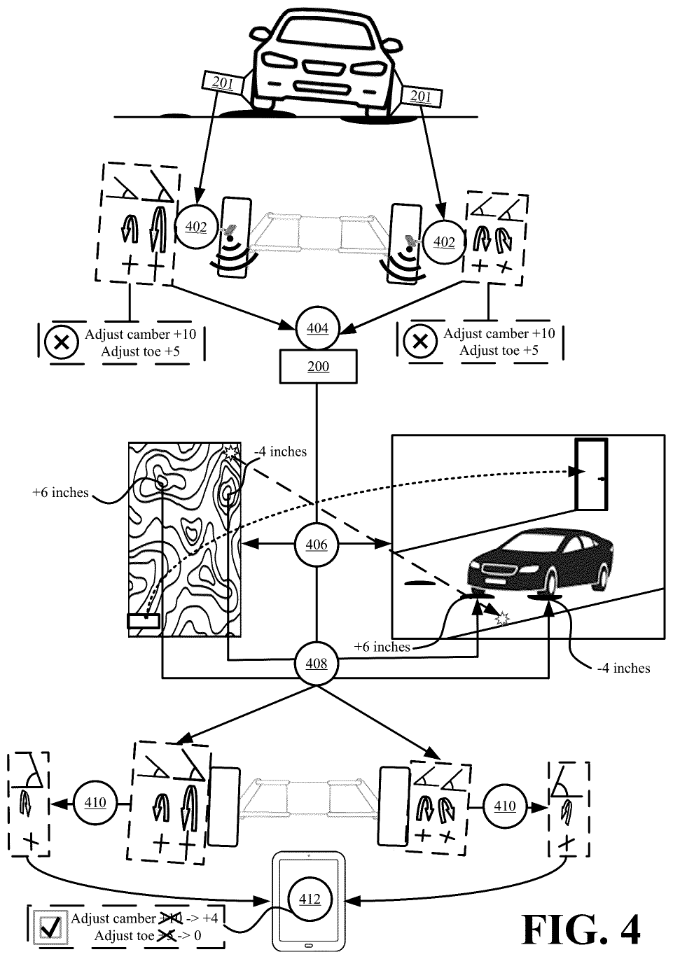

FIG. 4 illustrates an example of performing a dynamically adjusted wheel alignment to compensate for an unlevel surface in accordance with some embodiments presented herein. The vehicle is placed over an uneven or unlevel surface such that one or more of the wheels are at different heights and/or angles relative to one another. Moreover, the wheel may transition between different heights and angles when the vehicle is moved over the unlevel surface and comes into contact with different surface irregularities.

Sensor packages 201 are mounted on each wheel and measure (at 402) one or more of the angle, wheel rotation, range-of-motion, orientation, and/or characteristics of each wheel as the vehicle is moved forward or backward. The unlevel surface biases the measurements. In other words, the wheel alignment measurements generated by sensor packages 201 are affected and skewed by the unlevel surface over which the vehicle is positioned and the measurements are taken.

Vehicle service system 200 receives (at 404) the biased measurements from sensor packages 201. The biased measurements may be transmitted wirelessly to vehicle service system 200 as they are generated or once the diagnostics or wheel alignment tests are complete.

To correct for the bias, vehicle service system 200 aligns (at 406) the topographical map of the surface where the measurements are taken with an image that captures the vehicle over the surface. Aligning (at 406) the topographical with the image includes identifying one or more points-of-reference or differentiating features from the image with a mapping or representation of the same points-of-reference or differentiating features in the topographical map and/or transforming one or more of the image or topographical map so that the points-of-reference or differentiating features are at the same positions in the image and topographical map.

Vehicle service system 200 determines (at 408) the positional offset of each wheel relative based on surface irregularities or positional offsets defined in the topographical map at the mapped positions of each wheel. Vehicle service system 200 adjusts (at 410) the biased measurements output from sensor packages 201 to correct for the affect that the vertical offset has on the measurements. Vehicle service system 200 also outputs (at 412) adjusted camber, toe, and caster corrections based on the adjusted (at 410) measurements rather than incorrect camber, toe, and cast modifications based on alignment issues detected from the biased measurements and not accounting for the vertical offsets between the wheels due to the unlevel surface.

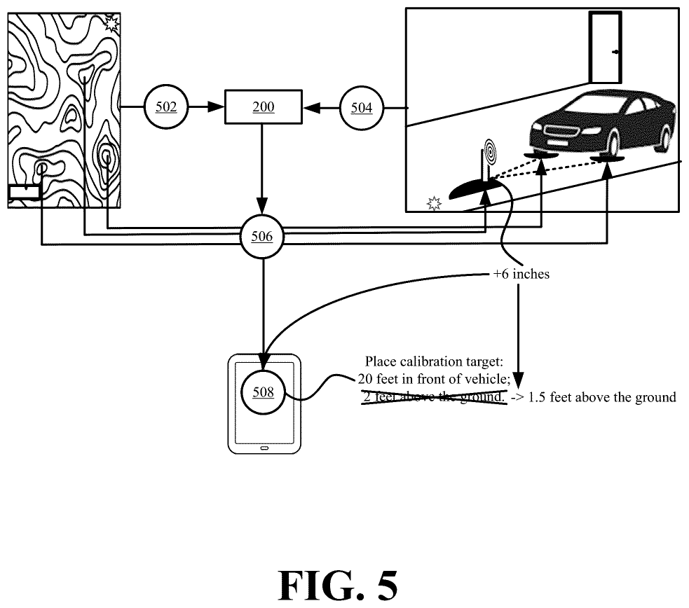

FIG. 5 illustrates an example of performing a dynamically adjusted calibration to correct for affects an unlevel surface has on the calibration in accordance with some embodiments presented herein. Vehicle service system 200 receives (at 502) a topographical map of the ground surface for the site at which ADAS or other vehicle calibration is to be performed. Vehicle service system 200 also receives (at 504) an image of the site with the vehicle at a first position and with a calibration target or equipment at a second position. Specifically, the calibration target is placed at a height and distance from the vehicle according to calibration specifications. For instance, the calibration specifications may require that the calibration target be placed twenty feet directly in front of the center of the vehicle at a height of two feet off the ground.

Vehicle service system 200 determines (at 506) the positional offsets between the first position of the vehicle and the second position of the calibration target by aligning the topographical map with the image and mapping the first position and the second position to height values or positional offsets measured at corresponding positions in the topographical map. In other words, vehicle service system 200 determines (at 506) whether the second position of the calibration target is level with the first position of the vehicle.

Vehicle service system 200 adjusts (at 508) the calibration specifications according to the determined (at 506) vertical offsets between the first position of the vehicle and the second position of the calibration target. In some embodiments, a user enters the calibration specifications specified by a vehicle manufacturer or ADAS provider into vehicle service system 200. In some other embodiments, vehicle service system 200 automatically retrieves the calibration specifications based on a make and model of the vehicle or a vehicle identification number.

In this example, vehicle service system 200 obtains calibration specifications that specify placing the calibration target twenty feet directly in front of the center of the vehicle at a height of two feet off the ground. Vehicle service system 200 determines that the ground surface twenty feet directly in front of the center of the vehicle (e.g., the second position) is six inches higher than the first position of the vehicle. Accordingly, vehicle service system 200 adjusts (at 508) the calibration specifications to lower the height of the calibration target by six inches (e.g., set the height of the calibration target to be one and a half feet off the ground surface) to compensate for the unevenness or difference in the level of the vehicle at the first position and the level of the calibration target at the second position. In some embodiments, vehicle service system 200 presents the adjusted calibration specifications on a display of a device used by a service technician to perform the calibration.

In some other embodiments, vehicle service system 200 is configured with the calibration specifications and receives (at 504) an image with the vehicle at the first position and without the calibration target having yet been positioned at the second position. In this case, vehicle service system 200 maps the position that is specified for the calibration target in the calibration specifications to the second position relative to the first position of the vehicle identified in the image, obtains the topographical values or ground surface level at the second position from the topographical map, and presents the adjusted second position to the service technician via a user interface or messaging. For instance, vehicle service system 200 may update the image or the user interface with a visual marker to indicate the second position and the adjusted height where the calibration target should be positioned relative to the vehicle. In some embodiments, vehicle service system 200 displays information to the service technician via a virtual reality, mixed reality, augment reality, or other spatial computing environment. In some such embodiments, vehicle service system 200 may overlay the adjusted position and height for the calibration target onto an image or the real-world view of the ground surface.

In some embodiments, vehicle service system 200 verifies or confirms that the calibration target has been correctly placed according to the adjusted calibration specifications before automatically controlling the activation of the vehicle calibration. In some such embodiments, vehicle service system 200 obtains positional measurements from a sensor of the calibration target and/or sensors of the vehicle to verify the correct adjusted positioning of the calibration target. As a result, the service technician may rely on vehicle service system 200 for instruction and verification as to the placement of the calibration target rather than manually measure and make incremental changes based on the imprecise manual measurements.

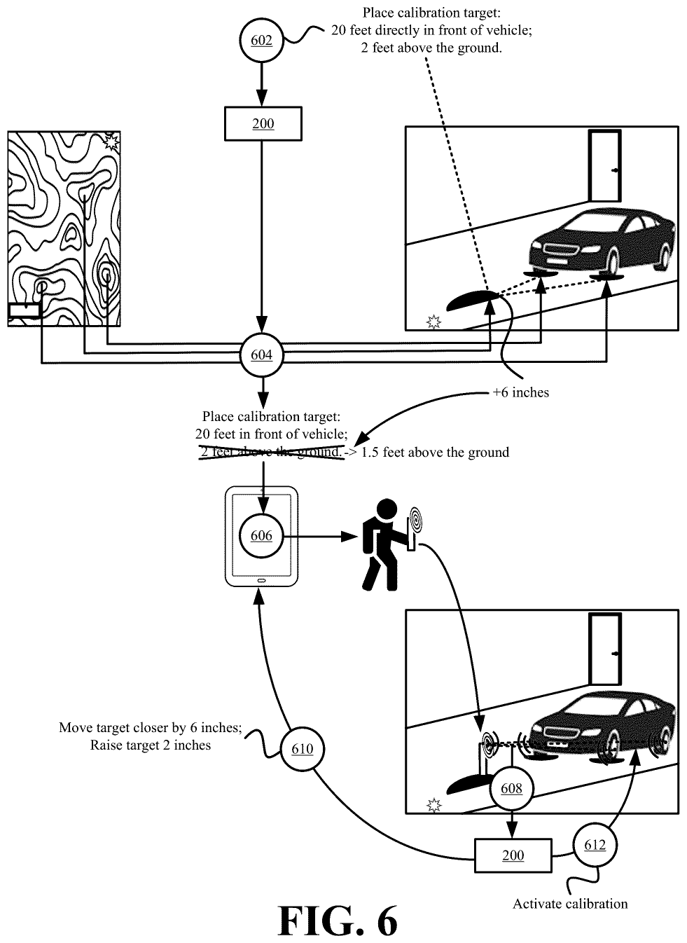

FIG. 6 illustrates an example of automatically controlling vehicle service in response to verifying dynamically adjusted settings and/or parameters for the vehicle service in accordance with some embodiments presented herein. Vehicle service system 200 is configured to perform an ADAS or driver-assist sensor calibration. Accordingly, vehicle service system 200 retrieves (at 602) calibration specifications defined by the vehicle manufacturer or the ADAS provider. The calibration specifications specify the 3D positions (e.g., positions and heights) at which to place one or more calibration targets relative to the vehicle for the ADAS calibration.

Vehicle service system 200 adjusts (at 604) the calibration specifications to compensate for the ground surface where the vehicle is positioned and where a particular calibration target is positioned being unlevel. Vehicle service system 200 obtains an image of the vehicle in a site and a generated topographical map for the positional and/or heights variations across the site surface. The topographical map is generated from accurately measuring the height of the ground surface at numerous points or positions across the ground surface. Vehicle service system 200 calculates the adjustments by mapping the position of the vehicle in the image to a corresponding position in the topographical map, mapping the position specified for the particular calibration target relative to the vehicle to a corresponding position in the topographical map, and determining the positional or height offset defined in the topographical map between the positions of the vehicle and the particular calibration target. For instance, adjusting (at 604) the calibration specifications may include raising the specified height for the particular calibration target based on a measured amount that the ground surface at the position of the particular calibration target is lower than the ground surface at the position of the vehicle. Similarly, adjusting (at 604) the calibration specifications may include lowering the specified height for the particular calibration target based on a measured amount that the ground surface at the position of the particular calibration target is higher than the ground surface at the position of the vehicle.

Vehicle service system 200 presents (at 606) the adjusted calibration specifications to a service technician. The service technician places the particular calibration target in the site according to the adjusted calibration specifications.

Vehicle service system 200 determines (at 608) the positions of the particular calibration target and the vehicle in 3D space based on signals received from sensors that are coupled to the particular calibration target and the vehicle (e.g., sensor packages 201 mounted to the vehicle wheels). For instance, the sensors may use UWB signaling to accurately determine the position and height of the particular calibration target relative to the vehicle.

In response to determining (at 608) that the position or the height of the particular calibration target relative to the vehicle is different than the adjusted (at 604) calibration specifications, vehicle service system 200 presents (at 610) instructions on a user device for additional positional or height corrections that are needed to commence the calibration. Vehicle service system 200 continually monitors the positioning of the particular calibration target and the vehicle based on the sensor signaling.

In response to determining (at 608) that the position and the height of the particular calibration target relative to the vehicle matches the adjusted (at 604) calibration specifications, vehicle service system 200 activates (at 612) the vehicle calibration. Activating (at 612) the vehicle calibration may include transmitting a command or signal to the vehicle computer (e.g., ADAS controller) to commence the calibration procedure in which the ADAS sensors emit signals and measure the reflection of the signals from the calibration target to determine if the ADAS sensors are functioning properly.

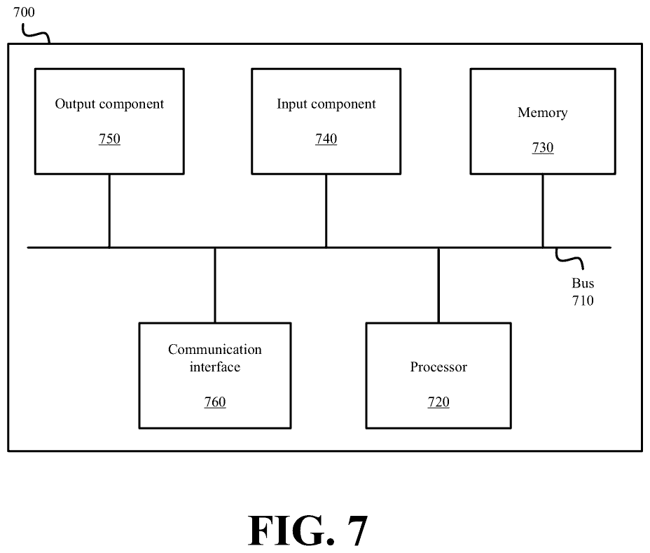

FIG. 7 is a diagram of example components of device 700. Device 700 may be used to implement one or more of the devices or systems described above (e.g., vehicle service system 200). Device 700 may include bus 710, processor 720, memory 730, input component 740, output component 750, and communication interface 760. In another implementation, device 700 may include additional, fewer, different, or differently arranged components.

Bus 710 may include one or more communication paths that permit communication among the components of device 700. Processor 720 may include a processor, microprocessor, or processing logic that may interpret and execute instructions. Memory 730 may include any type of dynamic storage device that may store information and instructions for execution by processor 720, and/or any type of non-volatile storage device that may store information for use by processor 720.

Input component 740 may include a mechanism that permits an operator to input information to device 700, such as a keyboard, a keypad, a button, a switch, etc. Output component 750 may include a mechanism that outputs information to the operator, such as a display, a speaker, one or more light emitting diodes (“LEDs”), etc.

Communication interface 760 may include any transceiver-like mechanism that enables device 700 to communicate with other devices and/or systems. For example, communication interface 760 may include an Ethernet interface, an optical interface, a coaxial interface, or the like. Communication interface 760 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 700 may include more than one communication interface 760. For instance, device 700 may include an optical interface and an Ethernet interface.

Device 700 may perform certain operations relating to one or more processes described above. Device 700 may perform these operations in response to processor 720 executing software instructions stored in a computer-readable medium, such as memory 730. A computer-readable medium may be defined as a non-transitory memory device. A memory device may include space within a single physical memory device or spread across multiple physical memory devices. The software instructions may be read into memory 730 from another computer-readable medium or from another device. The software instructions stored in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving a map comprising values for different heights measured across a surface;
determining a level of a vehicle located at a first position on the surface based on the values for the different heights specified at the first position in the map; and
adjusting a set of outputs associated with servicing the vehicle based on the level of the vehicle.

2. The method of claim 1 further comprising:
scanning the surface;
generating a plurality of measurements from scanning the surface; and
assigning the plurality of measurements to positions in the map that correspond to positions about the surface where the plurality of measurements were generated.

3. The method of claim 1 further comprising:
receiving an image with the vehicle at the first position on the surface;
aligning the image with the map based on common points-of-reference that are in the image and that are associated with the map; and
determining the values for the different heights that are specified at one or more positions in the map that correspond to the first position in the map after said aligning.

4. The method of claim 1 further comprising:
certifying that service is performed on the vehicle with the vehicle over a level surface or with the vehicle being level at a time of the service in response to determining the level of the vehicle and the level of the vehicle not varying over the surface.

5. The method of claim 1 further comprising:
receiving a plurality of measurements that are generated while the vehicle is over the surface; and
wherein adjusting the set of outputs comprises:
modifying the plurality of measurements based on an amount by which the vehicle is not level.

6. The method of claim 1 further comprising:
receiving a plurality of measurements that are generated while the vehicle is over the surface;
determining an affect that the level of vehicle has on the plurality of measurements; and
wherein adjusting the set of outputs comprises:
modifying the plurality of measurements based on the affect.

7. The method of claim 1 further comprising:
receiving a set of specifications for positioning service equipment relative to the vehicle; and
wherein adjusting the set of outputs comprises:
generating a set of modified specifications that adjust the set of specifications based on a difference between the different heights specified in the map for the first position of the vehicle and a second position specified by the set of specifications.

8. The method of claim 7, wherein the set of modified specifications comprises a height for the service equipment that is higher or lower than a height specified for the service equipment in the set of specifications.

9. The method of claim 1 further comprising:
detecting a fiducial in an image that captures the first position of the vehicle over the surface;
determining a particular position in the map that corresponds to the first position in the image in response to aligning the image with the map using the fiducial; and
wherein determining the level of the vehicle comprises:
determining an amount by which the vehicle is not level based on a value for the different height that is specified at the particular position in the map.

10. The method of claim 1 further comprising:
presenting the set of outputs after having been adjusted on a display.

11. The method of claim 1 further comprising:
activating a service operation of the vehicle in response to the set of outputs after having been adjusted satisfying a set of specifications associated with the service operation.

12. The method of claim 1,
wherein determining the level of the vehicle comprises determining that a first wheel of the vehicle is raised relative to a second wheel of the vehicle; and
wherein adjusting the set of outputs comprises modifying measurements generated from sensors placed on the vehicle based on the first wheel being raised relative to the second wheel.

13. The method of claim 1,
wherein determining the level of the vehicle comprises determining that a first wheel of the vehicle is raised relative to a second wheel of the vehicle; and
wherein adjusting the set of outputs comprises modifying parameters for a proper wheel alignment based on the first wheel being raised relative to the second wheel.

14. A vehicle service system comprising:
one or more hardware processors configured to:
receive a map comprising values for different heights measured across a surface;
determine a level of a vehicle located at a first position on the surface based on the values for the different heights specified at the first position in the map; and
adjust a set of outputs associated with servicing the vehicle based on the level of the vehicle.

15. The vehicle service system of 14, wherein the one or more hardware processors are further configured to:
scan the surface;
generate a plurality of measurements from scanning the surface; and
assign the plurality of measurements to positions in the map that correspond to positions about the surface where the plurality of measurements were generated.

16. The vehicle service system of 14, wherein the one or more hardware processors are further configured to:
receive an image with the vehicle at the first position on the surface;
align the image with the map based on common points-of-reference that are in the image and that are associated with the map; and
determine the values for the different heights that are specified at one or more positions in the map that correspond to the first position in the map after said aligning.

17. The vehicle service system of 14, wherein the one or more hardware processors are further configured to:
certify that service is performed on the vehicle with the vehicle over a level surface or with the vehicle being level at a time of the service in response to determining the level of the vehicle and the level of the vehicle not varying over the surface.

18. The vehicle service system of 14, wherein the one or more hardware processors are further configured to:
receive a plurality of measurements that are generated while the vehicle is over the surface; and
wherein adjusting the set of outputs comprises:
modifying the plurality of measurements based on an amount by which the vehicle is not level.

19. The vehicle service system of 14, wherein the one or more hardware processors are further configured to:
receive a plurality of measurements that are generated while the vehicle is over the surface;
determine an affect that the level of vehicle has on the plurality of measurements; and
wherein adjusting the set of outputs comprises:
modifying the plurality of measurements based on the affect.

20. A non-transitory computer-readable medium storing instructions that, when executed by one or more processors of a vehicle service system, cause the vehicle service system to perform operations comprising:
receiving a map comprising values for different heights measured across a surface;
determining a level of a vehicle located at a first position on the surface based on the values for the different heights specified at the first position in the map; and
adjusting a set of outputs associated with servicing the vehicle based on the level of the vehicle.
